(19) United States
(12) Patent Application Publication
(10) Pub. No.: US 2024/0209139 A1
(43) Pub. Date: Jun. 27, 2024

(54) ALDIMINE-UREA OLIGOMER

(71) Applicant: SIKA TECHNOLOGY AG, Baar (CH)

(72) Inventors: Urs BURCKHARDT, Zürich (CH); Andreas KRAMER, Zürich (CH); Michael SCHLUMPF, Stallikon (CH); Alex COUPE, Lancaster (GB)

(73) Assignee: SIKA TECHNOLOGY AG, Baar (CH)

(21) Appl. No.: 18/288,491

(22) PCT Filed: Apr. 14, 2022
(86) PCT No.: PCT/EP2022/060087

§ 371 Date: Oct. 26, 2023

(30) Foreign Application Priority Data
Jun. 23, 2021 (EP) 21181230.0

(51) Int. Cl. C08G 18/32; C08G 18/12; C08G 18/30

(52) U.S. Cl. CPC C08G 18/3256; C08G 18/12; C08G 18/307; C08G 2150/00; C08G 2170/00; C08G 2190/00

(57) ABSTRACT

A process of manufacturing an aldimine preparation, characterized in that at least one aldimine of the formula (I), at least one isocyanate of the formula (II), optionally at least one alcohol of the formula (III) and water are reacted until at least 95% of all the initially present isocyanate groups are converted, whereby the initial molar ratio of aldimine groups to [isocyanate groups minus hydroxyl groups of the alcohol of formula (III)] in the reaction mixture is in the range of 2/1 to 10/1. The obtained aldimine preparation is particularly suitable for the use as latent hardener for moisture-curing polyurethane compositions. It enables moisture-curing polyurethane compositions with a very low content of diisocyanate monomers, which cure to an elastic material of surprisingly high strength, e-modulus and low surface tack.

### TECHNICAL FIELD

Aldimines and their use as latent hardeners for moisture-curing polyurethanes, particularly for coatings, sealants and adhesives.

### STATE OF THE ART

Moisture-curing polyurethanes based on isocyanate-functional polymers are widely used for sealing, bonding and coating applications in construction and industrial assembly, such as deck caulks, joint sealants, adhesives for parquet, windows or façade elements, or as liquid-applied membranes for waterproofing roofs or balconies. They are easy to apply without a mixing process, cure with ambient moisture and provide a high level of adhesion and elasticity. When applied under high humidity conditions, they are prone to bubble formation caused by excessive release of carbon dioxide from the curing reaction. To prevent this, blocked amines, so-called latent hardeners, may be used, in particular aldimines such as those described for example in U.S. Pat. Nos. 7,625,993 and 8,252,859. Another drawback of moisture-curing polyurethanes is their tendency to remain somewhat tacky at the surface and/or develop limited mechanical strength and e-modulus, making them prone to dirt pick-up and/or degradation under outdoor weathering conditions, such as ponding water and UV exposure. These effects are pronounced for compositions based on aliphatic or cycloaliphatic diisocyanates, especially isophorone diisocyanate (IPDI), which are preferred for outdoor applications. The effects are particularly pronounced if these compositions have a low content of isocyanate groups due to a long chain length of the polymers and/or reduced diisocyanate monomer levels, e.g. below 0.5 weight-%, in particular below 0.1 weight-%. Since diisocyanate monomers are toxic and volatile substances which present a potential health risk for applicators, it is advantageous from an EH&S point of view to reduce their content in isocyanate-functional polymers, e.g. by distillation. To counteract the surface tack and limited strength and e-modulus of such compositions, crosslinkers such as oligomers of 1,6-hexane diisocyanate or isophorone diisocyanate may be used, but this leads to a loss of elongation and high stiffness limiting the elasticity of the products.

WO 2020/030607 describes the use of blocked amines as auxiliary curing agents for isocyanate-functional polymers from which most of the diisocyanate monomers have been removed by a separation process. These compositions cure quickly to form elastic materials with high elongation. Nevertheless, the mechanical performance, particularly in terms of the e-modulus, does not reach the level of conventional compositions.

U.S. Pat. No. 9,527,999 describes aqueous emulsions of oligomeric dialdimines of high molecular weight, prepared from the reaction of an ether group-containing dialdimine, an isocyanate-functional polymer and water. These emulsions are used as curing accelerators for pasty polyurethane compositions based on isocyanatefunctional polyether polymers, whereby the oligomeric dialdimine acts as a carrier and compatibilizer, allowing to bring considerable amounts of water into the composition without inducing phase separation.

US 2010/0015450 describes an isocyanate group-containing compound from the reaction of a dialdimine with a polyisocyanate and a sub-stoichiometic amount of water, as well as a process for reducing the content of diisocyanate monomers in isocyanate-functional polyurethane polymers.

US 2009/0159204 describes compositions containing an aldimine-containing compound which is a reaction product of an isocyanate-functional polymer and an aldimine with at least one hydroxyl-, mercapto- or amine-group in a stoichiometric or substoichiometric ratio between the hydroxyl-, mercapto- or amine-group of the aldimine and the isocyanate groups of the polymer.

### SUMMARY OF THE INVENTION

The task of this invention is to provide a method of reducing the surface tack and increasing the mechanical strength and e-modulus of moisture-curing polyurethane compositions, particularly compositions based on aliphatic or cycloaliphatic diisocyanates and/or with a low content of diisocyanate monomers, without having a negative effect on other important properties, such as elongation and elasticity of the cured material.

This task is achieved with an aldimine preparation obtained by the process according to claim 1. The inventive process is easy to perform and uses well available starting materials. It provides non-aqueous aldimine preparations which are liquid at room temperature and thus suitable for the use as latent hardeners for moisture-curing polyurethane compositions. Compared to other aldimine latent hardeners, the aldimine preparations from the inventive process are able to significantly improve the mechanical strength of the cured polyurethane compositions without compromising on elongation. They surprisingly allow to largely compensate for the loss of strength in compositions with a very low content of diisocyanate monomers. Furthermore, they significantly improve the surface quality of the cured compositions by reducing tackiness and dirt pick-up. The compositions are surprisingly storage stable, despite the presence of dissolved urea groups in the aldimine preparations.

The aldimine preparation from the inventive process enables moisture-curing polyurethane compositions and adhesives, sealants and coatings based thereon with good storage stability, good application properties, fast curing at sufficient open time and a very advantageous combination of high elongation and high mechanical performance in terms of e-modulus, tensile strength and tear strength, along with low surface tack and high durability under outdoor weathering conditions. This is most beneficial for compositions with a very low content of diisocyanate monomers, particularly less than 0.1 weight-%, and for compositions which are designed for high UV loads.

Other aspects of the invention are described in other independent claims. Preferred aspects of the invention are described in dependent claims.

### DETAILED DESCRIPTION OF THE INVENTION

The subject of the invention is a process of manufacturing an aldimine preparation, characterized in that
at least one aldimine of the formula (I),
at least one isocyanate of the formula (II),
optionally at least one alcohol of the formula (III),

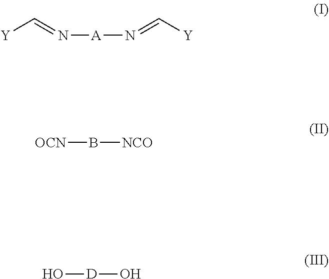

wherein
   Y is a monovalent C₁ to C₂₀ hydrocarbon group or a monovalent C₄ to C₂₀ hydrocarbon group containing ester or ether oxygen and/or tertiary amine nitrogen,
   A is a divalent C₂ to C₂₀ hydrocarbon group,
   B is a divalent C₄ to C₁₅ hydrocarbon group, and
   D is a C₂ to C₆ alkylene group,
and water
   are reacted until at least 95% of all the initially present isocyanate groups are converted, whereby the initial molar ratio of aldimine groups to [isocyanate groups minus hydroxyl groups of the alcohol of formula (III)] in the reaction mixture is in the range of 2/1 to 10/1.

In this document, the term “initial molar ratio” describes a molar ratio initially present in the reaction mixture at the start of the process according to the invention.

In this document, the term “moisture-curing polyurethane composition” refers to a composition based on isocyanate-functional (pre)polymers, which is stored in a single moisture-tight container, has shelf life stability and cures when exposed to moisture without the need for additional components. Such a composition is also called a “one-component” or “single-component” polyurethane composition.

In this document, the terms “shelf life stability” and “storage stability” refer to the ability of a composition to be stored at room temperature in a suitable container under exclusion of moisture for a certain time interval, in particular several months, without undergoing significant changes in application or end-use properties.

In this document, the term “molecular weight” refers to the molar mass (g/mol) of a molecule or a moiety of a molecule. The term “average molecular weight” refers to the number average molecular weight (Mₙ) of an oligomeric or polymeric mixture of molecules or moieties of molecules. It is determined by means of gel permeation chromatography (GPC) against polystyrene as the standard, particularly with tetrahydrofuran as the mobile phase and a refractive index detector.

In this document, the term “NCO-content” refers to the content of isocyanate groups in weight-% relative to a molecule or polymer or to a composition.

In this document, the term “aprotic organic liquid” refers to an organic substance which has no Zerevitinov-active hydrogen atoms, is liquid at room temperature and miscible with the aldimine preparation, acting as a solvent or diluent.

In this document, the term “plasticizer” refers to an organic substance of low volatility which has no Zerevitinov-active hydrogen atoms, is liquid at room temperature and has a plasticizing effect on a polyurethane composition. Such a plasticizer preferably has a vapor pressure of less than 0.1 mbar at 20° C. and/or a boiling point of above 240° C. at 1.013 bar.

In this document, the term “weight-%” refers to the mass fraction of a constituent of a composition based on the entire composition, unless stated otherwise. The terms “weight” and “mass” are used synonymously in this document.

The term “molar ratio” in relation to reactive groups refers to the ratio between the number of mol-equivalents of the respective reactive groups.

In this document, “room temperature” refers to a temperature of 23° C.

All industry standards and norms mentioned in this document refer to the versions valid at the time of filing the first application, if not specified.

In the inventive process, the initial molar ratio of water to [isocyanate groups minus hydroxyl groups of the alcohol of formula (III)] is preferably at least 1/1. This ensures that all initially present isocyanate groups can react with hydrolyzing aldimine groups.

Preferably, the initial molar ratio of water to [isocyanate groups minus hydroxyl groups of the alcohol of formula (III)] is in the range of 1/1 to 1.2/1, preferably 1/1 to 1.1/1. Particularly it is 1/1. If an excess water is used, i.e. an initial molar ratio of water to [isocyanate groups minus hydroxyl groups of the alcohol of formula (III)] of more than 1/1, the excess water is preferably removed from the aldimine preparation, preferably by vacuum distillation, preferably to such an extent, that the water content of the aldimine preparation is finally less than 0.5 weight-%, preferably less than 0.1 weight-%. This enables its use as latent hardener in moisture-curing polyurethane compositions.

In the inventive process, the initial molar ratio of aldimine groups to [isocyanate groups minus hydroxyl groups of the alcohol of formula (III)] in the reaction mixture is in the range of 2/1 to 10/1. This means, the number of all initially present aldimine groups in relation to the difference between the number of all initially present isocyanate groups and the number of all initially present hydroxyl groups is in the range of 2/1 to 10/1.

Preferably, the initial molar ratio of aldimine groups to [isocyanate groups minus hydroxyl groups of the alcohol of formula (III)] is in the range of 2.1/1 to 7/1, more preferably 2.2/1 to 6/1, particularly 2.3/1 to 5/1. Such an aldimine preparation is typically liquid at room temperature and enables a high strength.

In a particularly preferred embodiment of the invention, there is no alcohol of the formula (III) present in the inventive process. This enables a particularly low viscous aldimine preparation.

In another preferred embodiment of the invention, there is at least one alcohol of the formula (III) present in the inventive process. This enables moisture-curing polyurethane compositions with a particularly high strength.

Preferably, the initial molar ratio of hydroxyl groups to isocyanate groups is thereby in the range of 0.1/1 to 0.5/1, particularly 0.2/1 to 0.4/1.

In the aldimine of the formula (I), A is preferably a divalent C₄ to C₁₅ hydrocarbon group, more preferably a divalent C₆ to C₁₃ hydrocarbon group.

Particularly, A is the divalent radical of a diamine after removing the amine groups.

Preferred therefore are diamines selected from 1,2-ethanediamine, 1,2-propanediamine, 1,3-propanediamine, 2-methyl-1,3-propanediamine, 2,2-dimethyl-1,3-propanediamine, 1,3-butanediamine, 1,4-butanediamine, 1,3-pentanediamine (DAMP), 1,5-pentanediamine, 3-methyl-1,5-pentanediamine, 1,5-diamino-2-methylpentane (MPMD), 2-butyl-2-ethyl-1,5-pentanediamine (C₁₁-Neodiamine), 1,6-hexanediamine (HDA), 2,2(4), 4-trimethylhexamethylenediamine (TMD), 1,7-heptanediamine, 1,8-octanediamine, 1,9-nonanediamine, 1,10-decanediamine, 1,11-undecanediamine, 1,12-dodecanediamine, 1,2-, 1,3- or 1,4-diaminocyclohexane, 4,4′-, 2,4′- or 2,2′-methylene-bis(cyclohexylamine) (H₁₂-MDA), bis(4-amino-3-methylcyclohexyl)methane, bis(4-amino-3-ethylcyclohexyl)methane, isophorone diamine (IPDA; 3-aminomethyl-3,5,5-trimethylcyclohexylamine), 2- or 4-methyl-1,3-diaminocyclohexane, 1,3-bis(aminomethyl)cyclohexane, 1,4-bis(aminomethyl)cyclohexane, 2,5(2,6)-bis(aminomethyl)bicyclo[2.2.1]heptane (NBDA), 3(4),8(9)-bis(aminomethyl)tricyclo-[5.2.1.0^{2,6}]decane, 1,4-diamino-2,2,6-trimethylcyclohexane (TMCDA), 1,3-bis(aminomethyl)benzene (MXDA), 1,4-bis(aminomethyl)benzene, m-phenylenediamine, p-phenylenediamine, 4,4′-, 2,4′- and/or 2,2′-diaminodiphenylmethane (MDA) and 2,4- and/or 2,6-toluylenediamine (TDA).

Preferably, A is the divalent radical after removing the amine groups of a diamine selected from the group consisting of 1,6-hexanediamine, isophorone diamine, 4(2)-methyl-1,3-cyclohexanediamine, 4,4′-methylene-bis(cyclohexylamine) and 1,3-bis(aminomethyl)cyclohexane.

Particularly preferred thereof is the divalent radical of 1,6-hexanediamine or isophorone diamine.

Most preferred, A is the divalent radical of isophorone diamine after removing both amine groups.

In the aldimine of the formula (I), Y is preferably a monovalent C₃ to C₂₀ hydrocarbon group or a C₄ to C₂₀ hydrocarbon group containing ester or ether oxygen and/or tertiary amine nitrogen.

In a preferred embodiment of the invention, Y is a branched C₃ to C₇ alkyl group, preferably isopropyl or hept-3-yl, particularly isopropyl. Such an aldimine of the formula (I) is derived from an aliphatic C₄ to C₅ aldehyde, particularly isobutyraldehyde or 2-ethylhexanal. Such an aldimine preparation is particularly suitable for the use as latent hardener in moisture-curing polyurethane compositions with aliphatic isocyanate groups.

In another preferred embodiment of the invention, Y is a monovalent C to C₂₀ aromatic group, preferably phenyl or alkylphenyl, particularly p-(C₁₀-14 alkyl)phenyl, most preferably phenyl. Such an aldimine of the formula (I) is derived from an optionally substituted aromatic C₇ to C₂₁ aldehyde, particularly benzaldehyde, tolualdehyde or a p-(C₁₀-14 alkyl)benzaldehyde. Such an aldimine preparation is suitable for the use as latent hardener in moisture-curing polyurethane compositions with aliphatic or aromatic isocyanate groups.

In a particularly preferred embodiment of the invention, Y is a group of the formula

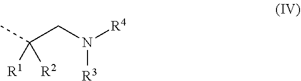

wherein
R¹ and R² are the same or different C₁ to C₄ alkyls, or are joined together to form a C₄ to C₆ alkylene, and
R³ and R⁴ are the same or different C₁ to C₈ alkyls or C₃ to C₈ alkyls containing ether oxygen,
or R³ and R⁴ are joined together to form a C₄ to C alkylene or a C₄ to C₆ alkylene containing ether oxygen.

Such an aldimine preparation is particularly suitable for the use as latent hardener of particularly low smell in isocyanate-functional sealants, adhesives and particularly coatings with aliphatic isocyanate groups and particularly high strength.

Preferably, R¹ and R² are both methyl.

Preferably, R³ and R⁴ are either both a methoxyethyl group or are joined together to form a 3-oxa-1,5-pentylene or a 2,4-dimethyl-3-oxa-1,5-pentylene group, which forms together with the nitrogen atom, to which R³ and R⁴ are bonded, a morpholine or a 2,6-dimethylmorpholine ring.

Particularly, R³ and R⁴ are joined together to form a 3-oxa-1,5-pentylene group which is part of a morpholine ring.

Most preferred, R¹ and R² are both methyl and R³ and R⁴ are together a 3-oxa-1,5-pentylene group, which forms together with the nitrogen atom, to which R³ and R⁴ are bonded, a morpholine ring.

In another particularly preferred embodiment of the invention, Y is a group of the formula (V),

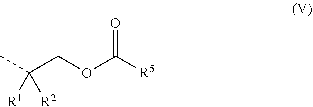

wherein
R¹ and R² are the same or different C₁ to C₄ alkyls, or are joined together to form a C₄ to C₆ alkylene, and
R⁵ is hydrogen or a monovalent C₁ to C₁₇ hydrocarbon optionally containing ether groups.

Such an aldimine preparation is particularly suitable for the use as latent hardener in isocyanate-functional sealants and adhesives with aliphatic or aromatic isocyanate groups.

Preferably, R¹ and R² are both methyl and R⁵ is methyl or undecyl.

An aldimine preparation with Y of the formula (V) with R¹ and R²=methyl and R⁵=methyl enables coatings based on aromatic or aliphatic isocyanates with particularly high strength.

An aldimine preparation with Y of the formula (V) with R¹ and R²=methyl and R⁵=undecyl enables sealants, adhesives or coatings based on aromatic or aliphatic isocyanates with particularly low smell and particularly high elongation.

Particularly preferred is an aldimine of the formula (I) wherein Y is a group of the formula (IV). These aldimines provide aldimine preparations which enable a particularly high strength.

Further particularly preferred is an aldimine of the formula (I) wherein Y is a group of the formula (V). These aldimines provide aldimine preparations which enable a good storage stability with highly UV stable aliphatic isocyanates such as IPDI or HDI as well as with highly reactive aromatic isocyanates such as MDI or TDI.

The aldimine of the formula (I) is preferably manufactured from an amine of the formula H₂N-A-NH₂ and at least one aldehyde of the formula

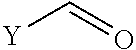

in a condensation reaction under removal of the condensation water. The amine of the formula H₂N-A-NH₂ is preferably a commercially available amine and used as purchased, without further purification.

The isocyanate of the formula (II) is preferably used as such in its pure form, preferably with a purity of at least 95 weight-%.

Preferably, there are no or only small amounts of isocyanate-functional substances different from isocyanates of the formula (II) initially present in the inventive process. Preferably, at least 90%, more preferably at least 95%, of all the isocyanate groups initially present in the process are from isocyanates of the formula (II).

Particularly, the inventive process is conducted in the absence of initially present isocyanate-functional polymers, in particular those obtained from the reaction of diisocyanate monomers with polyether polyols or other types of polyols, as those contained in the moisture-curing polyurethane composition described below.

In the isocyanate of the formula (II), B is preferably a divalent C₆ to C₁₃ hydrocarbon group.

Preferably, the isocyanate of the formula (II) is selected from the group consisting of 1,6-hexane diisocyanate (HDI), isophorone diisocyanate (IPDI), 4,4′-diisocyanatodicyclohexylmethane (H₁₂MDI), diphenylmethane diisocyanate (MDI) particularly 4,4′-diphenylmethane diisocyanate or its mixtures with 2,4′-diphenylmethane diisocyanate and 2,2′-diphenylmethane diisocyanate, and toluene diisocyanate (TDI) particularly 2,4-toluene diisocyanate or its mixtures with 2,6-toluene diisocyanate.

Particularly preferred thereof is IPDI. This isocyanate enables aldimine preparations of low viscosity and moisture-curing polyurethane compositions with high strength, long shelf life stability and particularly good UV stability.

Particularly preferred, A in the aldimine of the formula (I) and B in the isocyanate of the formula (II) are the same divalent radicals, particularly of isophorone diamine and isophorone diisocyanate after removing the amine groups and isocyanate groups.

Aldimine preparations derived from isophorone diamine and isophorone diisocyanate enable a particularly high strength, particularly when used as latent hardener for compositions based on isophorone diisocyanate. Such compositions enable sealants, adhesives or coatings with good UV stability, non-tacky surface and high strength at high elongation and elasticity at low content of diisocyanate monomers.

The alcohol of the formula (III) is preferably selected from the group consisting of 1,2-ethanediol, 1,3-propanediol, 2-methyl-1,3-propanediol, 1,4-butanediol, 1,5-pentanediol, 3-methyl-1,5-pentanediol and 1,6-hexanediol.

Particularly preferred thereof is 1,4-butanediol. The use of 1,4-butanediol provides aldimine preparations which enable a particularly high strength.

In the alcohol of the formula (III), D is therefore preferably 1,4-butylene.

The initial molar ratio of hydroxyl groups to isocyanate groups in the reaction mixture of the inventive process is preferably not more than 0.5/1.

In a preferred embodiment of the invention, there is at least one aprotic organic liquid present. This enables a particularly low viscosity and an easy handling of the reaction mixture and the obtained aldimine preparation.

The aprotic organic liquid has preferably a molecular weight of less than 500 g/mol and is preferably selected from aprotic solvents and plasticizers.

Suitable aprotic solvents are particularly acetone, methyl ethyl ketone, methyl n-propyl ketone, diisobutyl ketone, methyl isobutyl ketone, methyl n-amyl ketone, methyl isoamyl ketone, acetyl acetone, mesityloxide, cyclohexanone, methylcyclohexanone, methyl acetate, ethyl acetate, propyl acetate, butyl acetate, tert.butyl acetate, 1-methoxy-2-propylacetate (MPA), n-butyl propionate, ethyl-3-ethoxy propionate, diethyl malonate, diisopropyl ether, dibutyl ether, ethylene glycol diethylether, ethylene glycol monopropylether, ethylene glycol mono-2-ethylhexylether, diethylene glycol diethylether, propylal, butylal, 2-ethylhexylal, dioxolane, glycerolformal, 2,5,7,10-tetraoxaundecane (TOU), toluene, xylenes, heptanes, octanes, diisopropylnaphthalenes, petroleum fractions such as naphtha, white spirits or petroleum ethers such as Solvesso™ solvents (from Exxon), hydrogenated naphtha, methylene chloride, propylene carbonate (4-methyl-1,3-dioxolan-2-on), dimethyl carbonate, butyrolactone, N-methyl-pyrrolidone, N-ethylpyrrolidone, p-chlorobenzotrifluoride or benzotrifluoride.

Preferred thereof is MPA, propylene carbonate, dimethyl carbonate or TOU.

Suitable plasticizers are particularly phthalates, particularly diisononyl phthalate (DINP) or diisodecyl phthalate (DIDP), hydrogenated phthalates, particularly hydrogenated DINP, which is diisononyl-1,2-cyclohexane dicarboxylate (DINCH), terephthalates, particularly bis(2-ethylhexyl) terephthalate (DEHT) or diisononyl terephthalate (DINT), hydrogenated terephthalates, particularly bis(2-ethylhexyl)-1,4-cyclohexane dicarboxylate, trimellitates, adipates, particularly dioctyl adipate (DOA), azelates, sebacates, citrates, benzoates, glycol ethers, glycol esters, polyether monols or polyols with blocked hydroxyl groups particularly in the form of acetat groups, organic sulfonates or phosphates, particularly diphenylcresyl phosphate (DPK), polybutenes, polyisobutenes or plasticizers obtained from natual fats or oils such as epoxidized soy or linseed oil.

Preferred thereof is DOA, DINP, DIDP, DINCH or DEHT.

The aprotic organic liquid is preferably selected from the group consisting of 1-methoxy-2-propylacetate, propylene carbonate, dimethyl carbonate, 2,5,7,10-tetraoxaundecane, dioctyl adipate, diisononyl phthalate, diisodecyl phthalate, diisononyl 1,2-cyclohexanedicarboxylate and bis(2-ethylhexyl) terephthalate.

Particularly preferred is 1-methoxy-2-propylacetate, propylene carbonate or dimethyl carbonate, particularly for aldimine preparations derived from aldimines of the formula (I) wherein Y is a group of the formula (IV) or of the formula (V) with R⁵=methyl.

Particularly preferred is further diisononyl phthalate, diisodecyl phthalate, diisononyl 1,2-cyclohexanedicarboxylate or bis(2-ethylhexyl) terephthalate, particularly for aldimine preparations derived from aldimines of the formula (I) wherein Y is a group of the formula (V) with R⁵=undecyl.

The inventive process is preferably conducted at a temperature in the range of 20 to 100° C., possibly in the presence of at least one catalyst for the hydrolysis of aldimine groups and, if at least one alcohol of the formula (III) is present, possibly in the presence of at least one catalyst for the reaction of hydroxyl groups with isocyanate groups.

Suitable catalysts for the hydrolysis of aldimine groups are acid catalysts, particularly carboxylic acids or sulfonic acids, preferably aromatic carboxylic acids, particularly benzoic acid or salicylic acid.

Suitable catalysts for the reaction of hydroxyl groups with isocyanate groups are particularly metal catalysts, preferably dialkyltin complexes, in particular dibutyltin or dioctyltin carboxylates or acetoacetonates such as dibutyltin dilaurate (DBTDL), DBT(acac)₂ or dioctyltin dilaurate (DOTDL), or bismut(II) complexes, in particular bismut(Ill) carboxylates or ketoamidates or alcoholates such as bismut(Ill) neodecanoate.

Preferably, the aldimine of the formula (I), the isocyanate of the formula (II), optionally the alcohol of the formula (III) and optionally the aprotic organic liquid are mixed before the water is added. If a stoichiometric excess of water is used, unreacted water is preferably removed from the obtained aldimine preparation, preferably by vacuum distillation.

If there is no alcohol of the formula (III) present, the aldimine of the formula (I), the isocyanate of the formula (II), optionally the aprotic organic liquid and optionally a catalyst for the hydrolysis of aldimine groups are preferably mixed in any order, followed by the addition of the water. The reaction is conducted at a temperature in the range of 20 to 100° C.

If there is at least one alcohol of the formula (III) used, the process can be conducted in one step or in two steps.

In a one-step process, the aldimine of the formula (I), the isocyanate of the formula (II), the alcohol of the formula (III), optionally the aprotic organic liquid, optionally a catalyst for the hydrolysis of aldimine groups and optionally a catalyst for the reaction of hydroxyl groups with isocyanate groups are mixed in any order, followed by the addition of the water. The reaction is conducted as described above.

In a two-step process, the isocyanate of the formula (II) and the alcohol of the formula (III) are reacted first, optionally in the presence of an aprotic organic liquid and optionally in the presence of at least one catalyst for the reaction of hydroxyl groups with isocyanate groups. In the second step, the aldimine of the formula (I) and optionally a catalyst for the hydrolysis of aldimine groups is added to the reaction mixture followed by the addition of the water.

In the inventive process, the aldimine of the formula (I), the isocyanate of the formula (II), optionally the alcohol of the formula (III) and the water are reacted until at least 95%, preferably at least 99%, of all the initially present isocyanate groups in the reaction mixture are converted. This ensures that the obtained aldimine preparation is essentially free from isocyanate groups. Preferably, the aldimine preparation contains an amount of isocyanate groups of less than 0.05 weight-%, in particular less than 0.01 weight-%, based on the total aldimine preparation. Most preferably, it is free of isocyanate groups.

In one embodiment of the invention, it is preferred to add at least one amine of the formula H₂N-A-NH₂ to the obtained aldimine preparation in a substoichiometric amount of its amine groups in relation to the released aldehyde of the formula

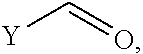

followed by the removal of the water from the condensation reaction between the amine and the aldehyde, preferably by vacuum distillation. This allows to form additional aldimine of the formula (I) in the aldimine preparation.

Such an aldimine preparation with an increased content of aldimine of the formula (I) is particularly cost-effective and enables moisture-curing polyurethane composition with a particularly high strength.

Preferably, at least one amine of the formula H₂N-A-NH₂ is added in a further step of the inventive process in a molar ratio of 0.2 to less than 0.5, preferably 0.3 to 0.45, per mol released aldehyde of the formula

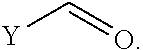

If the initial molar ratio of water to [isocyanate groups minus hydroxyl groups of the alcohol of formula (III)] in the inventive process is 1/1, as it is most preferred, the molar ratio of the released aldehyde to [isocyanate groups minus hydroxyl groups of the alcohol of formula (III)] is also 1/1.

In a preferred process the aldimine of the formula (I) is selected from N,N′-bis(2,2-dimethyl-3-lauroyloxypropylidene)-3-aminomethyl-3,5,5-trimethylcyclohexylamine, N,N′-bis(2,2-dimethyl-3-acetoxypropylidene)-3-aminomethyl-3,5,5-trimethylcyclohexylamine and N,N′-bis(2,2-dimethyl-3-(N-morpholino)propylidene)-3-aminomethyl-3,5,5-trimethylcyclohexylamine.

In a particularly preferred process
an aldimine selected from N,N′-bis(2,2-dimethyl-3-lauroyloxypropylidene)-3-aminomethyl-3,5,5-trimethylcyclohexylamine, N,N′-bis(2,2-dimethyl-3-acetoxypropylidene)-3-aminomethyl-3,5,5-trimethylcyclohexylamine and N,N′-bis(2,2-dimethyl-3-(N-morpholino)propylidene)-3-aminomethyl-3,5,5-trimethylcyclohexylamine,
isophorone diisocyanate, and
water
   are reacted until at least 95% of all the initially present isocyanate groups are converted, whereby the initial molar ratio of aldimine groups to isocyanate groups in the reaction mixture is in the range of 2.2/1 to 6/1 and the initial molar ratio of water to isocyanate groups is 1/1.

Another subject of the invention is the aldimine preparation obtained from the described process comprising aldimine group containing oligomers and at least one aldehyde of the formula

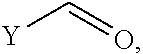

characterized in that said aldimine preparation contains less than 0.5 weight-% water and less than 0.05 weight-% isocyanate groups based on the total aldimine preparation.

Preferably, it further contains at least one aprotic solvent.

Optionally, it further contains a catalyst for the hydrolysis of aldimine groups and/or a catalyst for the reaction of isocyanate groups with hydroxyl groups.

The aldimine preparation is preferably liquid at room temperature. Preferably, it has a viscosity at 20° C. of less than 500 Pa·s, more preferably less than 100 Pa·s, particularly less than 50 Pa·s.

Preferably, the aldimine preparation is free of undissolved macroscopic particles of aldimine group containing oligomers.

Preferably, the aldimine group containing oligomers in the aldimine preparation obtained from the described process are oligomers of the formula (VI),

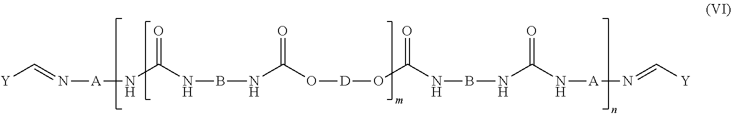

in which
n is a natural number in the range of 0 to 5,
m is a natural number in the range of 0 to 3,
and on average in the aldimine preparation, n is in the range of 0.25 to 2.5 and m is in the range of 0 to 2,
and Y, A, B and D are as already described.

Oligomers of the formula (VI), in which n and m are both zero, are aldimines of the formula (I).

If there was no alcohol of the formula (III) used in the inventive process, m in formula (VI) is zero.

If there was an alcohol of the formula (III) used in the inventive process, m is preferably on average in the range of 0.2 to 2.

A particularly preferred aldimine preparation is an aldimine preparation with oligomers of the formula (VI) wherein m is 0. It contains oligomers of the formula (VIa).

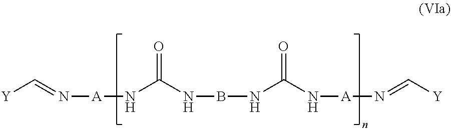

In a particularly preferred embodiment of the invention, Y is selected from a group of the formula (IV) and a group of the formula (V) and A and B each is the divalent radical of isophorone diamine or diisocyanate after removing the amine or isocyanate groups.

In a preferred embodiment, the aldimine preparation contains at least one aprotic organic liquid, preferably in an amount in the range of 5 to 90 weight-%, more preferably 10 to 85 weight-%, particularly 25 to 75 weight-%, based on the total weight of the aldimine preparation.

For aprotic solvents, the content is preferably in the range of 5 to 75 weight-%, particularly 10 to 50 weight-%.

For plasticizers, the content is preferably in the range of 25 to 75 weight-%.

The aldimine preparation contains less than 0.5 weight-% water, preferably less than 0.1 weight-% water.

The aldimine preparation contains less than 0.05 weight-%, preferably less than 0.01 weight-%, isocyanate groups.

A particularly preferred aldimine preparation contains at least one aprotic solvent selected from MPA, propylene carbonate, dimethyl carbonate and TOU, and oligomers of the formula (VI) wherein Y is a group of the formula (IV) with R¹ and R²=methyl and R³ and R⁴ are together a 3-oxa-1,5-pentylene group, which forms together with the nitrogen atom, to which R³ and R⁴ are bonded, a morpholine ring, and A and B are the same divalent radicals of isophorone diamine and isophorone diisocyanate after removing the amine groups and the isocyanate groups. Such an aldimine preparation is particularly suitable as latent hardener for elastic coatings of high strength with a low content of diisocyanate monomers.

Another particularly preferred aldimine preparation contains oligomers of the formula (VI) wherein Y is a group of the formula (V) with R¹ and R²=methyl and R⁵=undecyl, and A and B are the same divalent radicals of isophorone diamine and isophorone diisocyanate after removing the amine groups and the isocyanate groups and optionally at least one plasticizer selected from DOA, DINP, DIDP, DINCH and DEHT. Such an aldimine preparation is particularly suitable as latent hardener for elastic sealants and adhesives with a low content of diisocyanate monomers.

Another subject of the invention is the use of the aldimine preparation obtained from the inventive process as latent hardener for moisture-curing polyurethane compositions.

Such moisture-curing polyurethane compositions preferably contain polyisocyanates and/or isocyanate-functional polymers, preferably based on commercial diisocyanate monomers such as diphenylmethane diisocyanate (MDI), particularly 4,4′-diphenylmethane diisocyanate or its mixtures with 2,4′-diphenylmethane diisocyanate and 2,2′-diphenylmethane diisocyanate, toluene diisocyanate (TDI), particularly 2,4-toluene diisocyanate or its mixtures with 2,6-toluene diisocyanate, 1,4-phenylene diisocyanate (PDI), naphthalene-1,5-diisocyanate (NDI), 1,6-hexane diisocyanate (HDI), 2,2(4),4-trimethyl-1,6-hexamethylene diisocyanate (TMDI), cyclohexane-1,3- or-1,4-diisocyanate, isophorone diisocyanate (IPDI), methyldiisocyanatocyclohexane (HsTDI or HTDI), 4,4′-diisocyanatodicyclohexyl methane (H₁₂MDI), 1,3- or 1,4-bis(isocyanatomethyl)cyclohexane, m- or p-xylene diisocyanate (XDI) or m-tetramethylxylene diisocyanate (TMXDI).

Preferred thereof are MDI, TDI, HDI or IPDI.

MDI or TDI are particularly preferred in combination with an aldimine preparation, wherein Y is a monovalent C to C₂₀ aromatic group or in particular a group of the formula (V).

IPDI is particularly preferred in combination with an aldimine preparation, wherein Y is a branched C₃ to C₇ alkyl group or in particular a group of the formula (IV) or (V).

Preferably, the aldimine preparation is used in a substoichiometric amount of aldimine groups in relation to isocyanate group in the composition. Preferably, the ratio is in the range of 0.1 to 0.9, more preferably 0.2 to 0.8, particularly 0.2 to 0.7.

The aldimine preparation can be used in combination with a further aldimine, which is preferably an aldimine of the formula (I), wherein Y and A can be identical with Y and A in the aldimine preparation, or Y and/or A can be different from the Y and A in the aldimine preparation. If a combination between the aldimine preparation and further aldimines is used, the total number of all the aldimine groups in relation to the isocyanate groups in the composition is preferably less than 1, preferably 0.3 to 0.95, more preferably 0.4 to 0.9.

Another subject of the invention is a moisture-curing polyurethane composition comprising
at least one isocyanate-functional polymer with an NCO-content in the range of 0.5 to 8 weight-% based on the total polymer, and
the aldimine preparation obtained from the inventive process.

Preferably, the total number of aldimine groups from the aldimine preparation in relation to the total number of isocyanate groups in the composition is in the range of 0.1 to 0.9, preferably 0.2 to 0.8, particularly 0.2 to 0.7.

Preferably, the NCO-content of the isocyanate-functional polymer is in the range of 0.7 to 7 weight-%, particularly 0.9 to 6 weight-%, based on the total polymer.

The isocyanate-functional polymer preferably has an average molecular weight Mₙ in the range of 1′000 to 20′000 g/mol, preferably 1′500 to 15′000 g/mol, particularly 2′000 to 12′000 g/mol.

The isocyanate-functional polymer is preferably obtained from the reaction of at least one diisocyanate monomer and at least one polyol.

The diisocyanate monomer to obtain the isocyanate-functional polymer is preferably selected from the group consisting of MDI, TDI, PDI, NDI, HDI, TMDI, cyclohexane-1,3-diisocyanate, cyclohexane-1,4-diisocyanate, IPDI, H₆TDI, H₁₂MDI, 1,3-bis(isocyanatomethyl)cyclohexane, 1,4-bis(isocyanatomethyl)cyclohexane, XDI and TMXDI.

Preferred thereof are MDI, TDI, HDI or IPDI, preferably MDI, TDI or IPDI, particularly IPDI or MDI.

The polyol is preferably selected from the group consisting of polyether polyols, polyester polyols, polycarbonate polyols and polyacrylate polyols.

The isocyanate-functional polymer is preferably liquid at room temperature.

Preferred are isocyanate-functional polymers of low viscosity, preferably with a viscosity of less than 50 Pa·s, more preferably less than 30 Pa·s, particularly less than 20 Pa·s, measured by a cone-plate-viscometer with a cone diameter of 25 mm, cone angle of 1° at a cone-plate-distance of 0.05 mm and a shear rate of 10 s⁻¹ at 20° C.

The polyol is preferably a polyether polyol or a mixture of at least one polyether polyol and at least one further polyol selected from polyester polyols, polycarbonate polyols and polyacrylate polyols.

The polyether polyol preferably has repetitive units selected from 1,2-ethyleneoxy, 1,2-propyleneoxy, 1,3-propyleneoxy, 1,2-butyleneoxy and 1,4-butyleneoxy. Particularly preferred are 1,2-propyleneoxy units, optionally in combination with some 1,2-ethyleneoxy units at the end of the chains. Further particularly preferred are 1,4-butyleneoxy units.

Preferred are polyetherpolyols with a content of unsaturation below 0.02 mEq/g, preferably below 0.01 mEq/g.

Preferred are polyoxypropylene diols or triols, which optionally are ethyleneoxideendcapped, with an OH-number in the range of 7 to 175 mg KOH/g, preferably 10 to 145 mg KOH/g, particularly 14 to 112 mg KOH/g.

The polyol preferably has an average OH-functionality in the range of 1.7 to 3.

Particularly preferred are polyoxypropylene diols, which optionally are ethyleneoxide-endcapped, with an average molecular weight Mₙ in the range of 1′000 to 12′000 g/mol, preferably 2′000 to 8′000 g/mol.

Particularly preferred are further trimethylolpropane- or glycerine-started polyoxypropylene triols, which optionally are ethyleneoxide-endcapped, with an average molecular weight Mₙ in the range of 3′000 to 8′000 g/mol.

Preferred are further poly(oxy-1,4-butylene) diols with an average molecular weight Mₙ in the range of 650 to 2′000 g/mol.

Preferably, the isocyanate-functional polymer has an NCO-content in the range of 0.7 to 7 weight-% and is obtained from at least one polyether polyol.

The isocyanate-functional polymer is preferably prepared by combining the at least one diisocyanate monomer and the at least one polyol in a molar NCO/OH ratio of at least 1.3, preferably at least 1.5, more preferably at least 1.8, in the absence of moisture at a temperature in the range of 20 to 160° C., preferably 40 to 140° C., optionally in the presence of a suitable catalyst.

A particularly preferred isocyanate-functional polymer has a content of diisocyanate monomers below 0.5 weight-%, preferably below 0.3 weight-%, more preferably below 0.2 weight-%. An isocyanate-functional polymer with such a low content of diisocyanate monomers allows to formulate curable compositions which have an overall content of monomeric diisocyanates below 0.1 weight-%. Such compositions are safe to use without special protective measures and do not require hazard labelling.

For such a polymer, the reaction is preferably conducted at a molar NCO/OH ratio of at least 3/1, followed by the removal of diisocyanate monomers by a distillation process.

Preferably, the molar NCO/OH ratio is in the range of 3/1 to 10/1, preferably 3/1 to 8/1.

After the reaction, remaining diisocyanate monomers are preferably removed from the reaction mixture by a distillation process, preferably by thin film distillation or short path distillation, preferably under vacuum.

Particularly preferred is a multi step process, in which diisocyanate monomers are removed in a short path evaporator at a jacket temperature in the range of 120 to 200° C., preferably 140 to 180° C., at a pressure of 0.001 to 0.5 mbar.

Preferably, the reaction between the diisocyanate monomer and the polyether polyol as well as the removal of diisocyanate monomers is conducted in the absence of a solvent or entrainer.

Preferably, the isocyanate functional polymer has a content of diisocyanate monomers below 0.5 weight-%, preferably below 0.3 weight-%, more preferably below 0.2 weight-%, and is obtained from the reaction of at least one diisocyanate monomer and at least one polyol at a molar NCO/OH-ratio of at least 3/1, followed by removing diisocyanate monomers by a distillation process.

Preferably, it is manufactured with a molar NCO/OH ratio is in the range of 3/1 to 10/1, preferably 3/1 to 8/1.

Preferably, it is based on a polyether polyol.

Preferably, it is based on a diisocyanate monomer which is IPDI, TDI or MDI, particularly IPDI or 4,4′-diphenylmethane diisocyanate, most preferably IPDI.

The moisture-curing polyurethane composition may contain one or more than one isocyanate-functional polymers.

The moisture-curing polyurethane composition preferably contains an amount of diisocyanate monomers below 0.1 weight-% in relation to the total composition.

Such a composition enables a safe use for the applicator without special protective measures and without hazard labelling. The presence of the aldimine preparation surprisingly enables the composition to develop high strength at high elongation together with a dry, non-tacky surface. This is in marked contrast to state-of-the-art moisture-curing polyurethane compositions with a low diisocyanate monomer content, which typically develop limited strength and show significant surface tack after curing.

Preferably, the moisture-curing polyurethane composition contains at least one further ingredient selected from the group consisting of latent hardeners different from the aldimine preparation from the inventive process, oligomeric polyisocyanates, fillers, plasticizers, catalysts and stabilizers.

Preferred latent hardeners are oxazolidines, bis-oxazolidines or polyaldimines.

Particularly preferred are aldimines of the formula (I) additional to the ones which are part of the aldimine preparation.

Further particularly preferred are aldimines derived from polyoxypropylene diamines or triamines, particularly with an average molecular weight Mₙ in the range of 200 to 5'000 g/mol, preferably 200 to 500 g/mol.

A preferred oligomeric diisocyanate is an oligomeric TDI, a biuret or isocyanurate or uretdione or iminooxadiazindione or allophanate of HDI, an isocyanurate of IPDI or a mixed isocyanurate based on TDI and HDI. Particularly preferred is an isocyanurate of isophorone diisocyanate. Such an oligomeric diisocyanate can help to achieve a high strength. However, its use is limited to a certain extent, as it can cause a dramatic increase in stiffness with reduction of elongation up to total brittleness when used in a too high amount.

Suitable fillers are ground or precipitated calcium carbonates (chalk), which are optionally surface coated with a fatty acid such as stearate, barium sulfate (barytes), slate, silicates (quartz), magnesiosilicates (talc) or alumosilicates (clay, kaolin), dolomite, mica, glass bubbles, silicic acid, particularly highly dispersed silicic acids from pyrolytic processes (fumed silica), carbon black, microspheres, pigments, particularly titanium dioxide or iron oxides, or flame-retarding fillers such as aluminium hydroxides, particularly aluminium trihydroxide (ATH), magnesium dihydroxide, antimony trioxide, antimony pentoxide, boric acid, zinc borate, zinc phosphate, melamine borate, melamine cyanurate, ethylenediamine phosphate, ammonium polyphosphate, di-melamine orthophosphate, di-melamine pyrophosphate, hexabromocyclododecane, decabromodiphenyl oxide and tris(bromoneopentyl) phosphate.

Preferred fillers are chalk, barytes, alumosilicates, fumed silica, carbon black and/or ATH.

Suitable plasticizers are phthalates, particularly diisononyl phthalate (DINP) or diisodecyl phthalate (DIDP), hydrogenated phthalates, particularly hydrogenated DINP, which is diisononyl-1,2-cyclohexane dicarboxylate (DINCH), terephthalates, particularly bis(2-ethylhexyl) terephthalate (DEHT) or diisononyl terephthalate (DINT), hydrogenated terephthalates, particularly bis(2-ethylhexyl)-1,4-cyclohexane dicarboxylate, trimellitates, adipates, particularly dioctyl adipate (DOA), azelates, sebacates, citrates, benzoates, glycol ethers, glycol esters, polyether monols or polyols with blocked hydroxyl groups particularly in the form of acetat groups, organic sulfonates or phosphates, particularly diphenylcresyl phosphate (DPK), polybutenes, polyisobutenes or plasticizers obtained from natual fats or oils such as epoxidized soy or linseed oil.

Suitable catalysts for the acceleration of aldimine hydrolysis are acid catalysts, particularly carboxylic acids or sulfonic acids, preferably aromatic carboxylic acids such as benzoic acid or salicylic acid.

Suitable catalysts for the reaction of hydroxyl groups with isocyanate groups are particularly metal catalysts, preferably dialkyltin complexes, in particular dibutyltin or dioctyltin carboxylates or acetoacetonates such as dibutyltin dilaurate (DBTDL), DBT(acac)₂ or dioctyltin dilaurate (DOTDL), or bismut(III) complexes, in particular bismut(III) carboxylates or ketoamidates or alcoholates such as bismut(III) neodecanoate, or amine catalysts, preferably tertiary aminoethers, in particular 2,2′-dimorpholinodiethylether (DMDEE).

Preferred stabilizers are UV stabilizers and or heat stabilizers, particularly UV absorbers such as 2-cyano-3,3-diphenylacrylic acid ethyl ester, or hindered amine light stabilisers (HALS), such as bis(1,2,2,6,6-pentamethyl-4-piperidyl) sebacate.

The moisture-curing polyurethane composition may further contain the following ingredients:
drying agents, particularly molecular sieves, calcium oxide, highly reactive isocyanates such as p-tosylisocyanate, mono-oxazolidines such as Incozol® 2 (from Incorez) or orthoformic acid ester,
adhesion promoters, particularly organoalkoxy silanes such as 3-glycidoxypropyltrimethoxysilane, 3-glycidoxypropyltriethoxysilane, (meth)acrylosilanes, anhydridosilanes, carbamatosilanes, alkylsilanes or iminosilanes, or oligomers thereof, or titanates,
thickeners, such as bentonites, derivates of castor oil, hydrogenated castor oil, polyamides, polyamide waxes, polyurethanes, urea compounds, fumed silica, cellulose ethers or hydrophobically modified polyoxyethylenes,
organic solvents, particularly acetone, methyl ethyl ketone, methyl n-propyl ketone, diisobutyl ketone, methyl isobutyl ketone, methyl n-amyl ketone, methyl isoamyl ketone, acetyl acetone, mesityloxide, cyclohexanone, methylcyclohexanone, methyl acetate, ethyl acetate, propyl acetate, butyl acetate, tert.butyl acetate, 1-methoxy-2-propylacetate, n-butyl propionate, ethyl-3-ethoxy propionate, diethyl malonate, diisopropyl ether, dibutyl ether, ethylene glycol diethylether, ethylene glycol monopropylether, ethylene glycol mono-2-ethylhexylether, diethylene glycol diethylether, propylal, butylal, 2-ethylhexylal, dioxolane, glycerolformal, 2,5,7,10-tetraoxaundecane (TOU), toluene, xylenes, heptanes, octanes, diisopropylnaphthalenes, petroleum fractions such as naphtha, white spirits or petroleum ethers such as Solvesso™ solvents (from Exxon), hydrogenated naphtha, methylene chloride, propylene carbonate, dimethyl carbonate, butyrolactone, N-methyl-pyrrolidone, N-ethyl-pyrrolidone, p-chlorobenzotrifluoride or benzotrifluoride,
fibres, particularly glass fibres, carbon fibres, metallic fibres, ceramic fibres, plastic fibres, particularly polyamide fibres or polyethylene fibres, or natural fibres such as wool, cellulose, hemp or sisal,
nanofillers such as graphene or carbon nanotubes,
dyes,
natural resins, fats or oils such as rosin, shellac, linseed oil, castor oil or soybean oil,
non-reactive polymers, particularly homo- or copolymers of unsaturated monomers, particularly ethylene, propylene, butylene, isobutylene, isoprene, vinylacetate or alkyl(meth)acrylates, preferably polyethylene (PE), polypropylene (PP), polyisobutylene, ethylenevinyl acetate copolymers (EVA) or atactic poly-α-olefins (APAO),
additives such as wetting agents, flow enhancers, leveling agents, defoamers, deaerating agents, stabilizers, antioxidants or biocides.

The moisture-curing polyurethane composition preferably contains an amount of isocyanate-functional polymers in the range of 15 to 80 weight-%, particularly 20 to 50 weight-%, in relation to the total composition.

The moisture-curing polyurethane composition preferably contains such an amount of aldimines, that the total number of aldimine groups in relation to the isocyanate groups in the composition is in the range of 0.1 to 1, preferably 0.2 to 0.95, particularly 0.3 to 0.9.

The moisture-curing polyurethane composition preferably contains an amount of plasticizers in the range of 0 to 40 weight-%, preferably 10 to 30 weight-%, in relation to the total composition.

The moisture-curing polyurethane composition preferably contains an amount of fillers in the range of 0 to 80 weight-%, preferably 20 to 60 weight-%, in relation to the total composition.

In a preferred embodiment of the invention, the moisture-curing polyurethane composition contains at least one flame-retarding ingredient, preferably a flame retarding filler and/or a flame-retarding plasticizer. Such a composition is particularly preferred as coating for the waterproofing of buildings, particularly on roofs.

A preferred flame-retarding filler is aluminium trihydroxide (ATH). A preferred flame-retarding plasticizer is diphenylcresyl phosphate (DPK).

A particularly preferred moisture-curing polyurethane composition contains at least one trimer of 1,6-hexamethylene diisocyanate or at least one trimer of isophorone diisocyanate.

In one embodiment of the invention, the moisture-curing polyurethane composition preferably contains a low amount of volatile organic solvents with a boiling point at atmospheric pressure of below 200° C. Preferably, it contains not more than 200 g, more preferably not more than 150 g, of volatile organic solvents with a boiling point at atmospheric pressure of below 200° C. per liter of the total composition.

Such a composition is particularly suitable as coating, particularly for the waterproofing of buildings or as outdoor floor covering.

In a further embodiment of the invention, the moisture-curing polyurethane composition preferably contains an even lower content of volatile organic solvents with a boiling point at atmospheric pressure of below 200° C., preferably less than 10 weight-%, more preferably less than 5 weight-%, most preferably less than 1 weight-%, in relation to the total composition. Such a composition is particularly suitable as adhesive, joint filler or floor covering.

The moisture-curing polyurethane composition is prepared by mixing all ingredients under exclusion of moisture to obtain a macroscopically homogeneous fluid or paste and stored in a moisture-tight container at ambient temperatures. A suitable moisture-tight container consists preferably of an optionally coated metal or plastic. It is preferably a bucket, a barrel, a hobbock, a bag, a sausage, a cartridge, a can, a bottle or a tube. With suitable packaging and storage, the polyurethane composition shows a good shelf life stability.

The process of curing begins when the packaging is opened and the moisture curing polyurethane composition is applied, thereby getting in contact with moisture, especially atmospheric moisture. Upon curing, the isocyanate groups react under the influence of moisture with the hydrolyzing aldimine groups. Further isocyanate groups can react with each other under the influence of moisture. As a result of these reactions, the composition cures to form an elastic material.

In the course of the curing reaction, an aldehyde of the formula

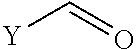

is released. Depending on the substituent Y, the aldehyde is volatile and may evaporate from the applied composition within a certain time, or it is of low volatility and partly or mostly remains in the cured composition.

After contact with moisture, the cured composition, which is an elastic material of surprisingly high strength, is obtained from the moisture-curing polyurethane composition.

The moisture for the curing of the composition is preferably atmospheric moisture, which penetrates into the applied composition from the surrounding air via diffusion processes. Upon curing, first a thin skin of cured composition is formed at the surface of the applied composition, which continuously grows in thickness as the curing process proceeds, until all of the applied composition is cured. Additional moisture contributing to the curing process may come from the substrates, to which the composition is applied, and/or from a water-containing or water-releasing accelerator component, which can be mixed into the composition before or during its application, or can be sprayed or brushed onto the surface of the applied composition.

The moisture-curing polyurethane composition is preferably applied at ambient conditions, preferably in a temperature range of −10 to 50° C., more preferably −5 to 45° C., particularly 0 to 40° C.

The curing of the composition preferably also takes place at ambient conditions.

The moisture-curing polyurethane composition has a sufficient open time to allow precise positioning and large surface applications and a fast curing progress, whereby the composition soon becomes tack-free and shows a fast build-up of mechanical strength and elasticity.

“Open time” is the time period, within which the applied composition can be processed or reworked without any negative effect. It is over when the viscosity of the composition due to progressing curing has risen too much, at the latest when a skin is formed on the surface. The time period, until a skin is formed on the surface, is called “skin formation time” or “skinning time”.

The moisture-curing polyurethane composition is preferably used as an elastic adhesive and/or sealant or as an elastic coating or as primer, paint or varnish.

Another subject of the invention is therefore an elastic adhesive, elastic sealant, elastic coating, primer, paint or varnish obtained from the described moisture-curing polyurethane composition after its contact with moisture, particularly atmospheric moisture.

Preferred is the use as an elastic adhesive and/or sealant. Such a composition is particularly suitable for the use in the construction or manufacturing industry or in vehicle construction, particularly for parquet bonding, assembly or module bonding, or as joint or cavity sealing and caulking, for example for high-rise façades or ship decks, which are exposed to particularly high UV load.

Further preferred is the use as an elastic coating. Such a composition is particularly suitable to seal and protect buildings or parts of a building, such as a floor, a footbridge, a balcony, a terrace, a roof, particularly a flat or a slightly sloping roof, a roof garden, or in the inner parts of a building under ceramic tiles in wet rooms or kitchens, or in sumps, channels, shafts, silos, tanks or wastewater treatment plants.

It can also be used for repair purposes, particularly on damaged roof membranes, floor coverings or sprayed membranes.

The moisture-curing polyurethane composition may be formulated in such a way, that it has a pasty consistency with pseudoplastic properties. Such a composition is preferably applied from a cartridge, a barrel or a hobbock, for example in the form of a bead with a round or triangular cross-sectional area.

The moisture-curing polyurethane composition may further be formulated in such a way, that it has a fluid consistency with self-levelling properties, optionally with a slight thixotropy. Such a composition can be applied by spraying or pouring onto a flat or slightly sloped surface, or with a roller or brush.

To form an even coating, the composition can optionally be spread to the desired layer thickness with a suitable tool, such as a squeegee, a toothed trowel, a spatula, a roller, a brush or a draw down bar. A layer thickness in the range of 0.5 to 3 mm, preferably 0.5 to 2 mm, is typically applied in one step.

Suitable substrates, onto which the composition is typically applied, are particularly—concrete, lightweight concrete, mortar, cement, fiber cement, brick, adobe, tile, slate, gypsum, gypsum panels, or natural stone, such as granite or marble,
glass or glass ceramic;
repair or levelling compounds based on PCC (polymer modified cement) or ECC (epoxy modified cement);
metals and alloys, such as aluminium, copper, iron, steel, nonferrous metals, including surface-finished metals and alloys, such as galvanized metals or chrome-plated metals;
asphalt;
bituminous felt;
plastics, such as hard or soft PVC, polycarbonate, polystyrene, polyester, polyamide, PMMA, ABS, SAN, epoxide resins, phenolic resins, PUR, POM, TPO, PE, PP, EPM or EPDM, in untreated form or surface-treated by means of plasma, corona or flame;
fibre reinforced plastics such as carbon fibre reinforced plastics, glass fibre reinforced plastics or sheet moulding compounds;
timber or plywood, paper, cardboard, wood materials bonded with organic resins, resin-textile composites or so-called polymer composites;
insulating foams, particularly out of EPS, XPS, PUR, PIR, rock wool, glass wool or foamed glass;
coated substrates, such as varnished tiles, painted concrete, coated metals or varnished metal sheets.

These substrates are optionally pre-treated before the application of the composition, particularly by a physical and/or chemical cleaning process or by the application of an activator or primer.

It is possible to bond or seal identical or different substrates.

An elastic adhesive and/or sealant is preferably used to make an elastic bond, preferably by a method comprising the steps of
(i) applying the moisture-curing polyurethane composition
   onto a first substrate and contacting the composition with a second substrate within the open time of the composition, or
   onto a first and onto a second substrate and join the two substrates within the open time of the composition, or
   between two substrates,
(ii) followed by curing the composition by contact with moisture.

For this method, the composition preferably has a pasty consistency and a content of volatile organic solvents below 5 weight-% based on the composition.

An elastic coating or sealant can further be used by a method of making an elastic coating and/or sealing, comprising the steps of
(i) applying the moisture-curing polyurethane composition onto a substrate
(ii) curing the composition by contact with moisture.

For this method, the composition preferably has a liquid, low viscous consistency.

In a preferred embodiment, the elastic coating is part of a floor system, particularly an outdoor floor system, preferably on a balcony, a terrace, a footbridge or a staircase.

In another preferred embodiment, the elastic coating is part of an elastic waterproofing system, particularly for the waterproofing of a low slope roof.

As a result of the described uses, an article is obtained, which is bonded, sealed and/or coated with the described moisture-curing polyurethane composition. This article is preferably a building or an infrastructure, or a part of these, preferably a bridge, a roof, a balcony, a terrace, a staircase or a façade, or it is an industrial good or a consumer good, or a part of these, particularly a window, a pipe, a household machine, a car, a bus, a truck, a rail vehicle, a ship, an airplane or a helicopter.

The moisture-curing polyurethane composition described herein has a number of advantages. It has a good storage stability, is easy to apply and cures quickly to form an elastic material of particularly high strength. It enables products with a very low content of diisocyanate monomers, which are safe for the user and the environment and have a high strength at high elongation together with a dry, non-tacky surface. The use of the aldimine preparation according to the invention allows to compensate or even exceed the loss of properties caused by the removal of a major part of the diisocyanate monomers from the composition.

### Examples

The following examples illustrate the present invention without being limiting.

“Normal climate” means a temperature of 23±1° C. and a relative atmospheric moisture of 50±5% and is abbreviated with “NC”.

Chemical substances not otherwise specified are from Sigma-Aldrich Chemie GmbH and were used as obtained.

### Preparation of Aldimines:

The amine content (total content of free amines and blocked amines, i.e. aldimino groups) of the prepared aldimines was determined by titration (with 0.1N HClO₄ in acetic acid against crystal violet).

### Aldimine A1: N,N′-bis(2,2-dimethyl-3-lauroyloxypropylidene)-3-aminomethyl-3,5,5-trimethylcyclohexylamine

598 g (2.1 mol) 2,2-dimethyl-3-lauroyloxypropanal were placed in a round bottom flask under nitrogen atmosphere. Then 170.3 g (1 mol) 3-aminomethyl-3,5,5-trimethylcyclohexylamine (Vestamin® IPD, from Evonik) were added under good stirring, followed by removing the volatile contents at 80° C. and 10 mbar vacuum. The yield was 732 g of a nearly colourless liquid with an amine content of 2.73 mmol N/g, corresponding to a calculated aldimine equivalent weight of approx. 367 g/eq.

### Aldimine A2: N,N′-bis(2,2-dimethyl-3-lauroyloxypropylidene)-1,6-hexanediamine

100.0 g (0.35 mol) 2,2-dimethyl-3-lauroyloxypropanal were placed in a round bottom flask under nitrogen atmosphere. Then 26.5 g (0.16 mol) 1,6-hexanediamine solution (70 weight-% in water) were added under good stirring, followed by removing the volatile contents at 80° C. and 10 mbar vacuum. The yield was 111.6 g of a nearly colourless liquid with an amine content of 2.85 mmol N/g, corresponding to a calculated aldimine equivalent weight of approx. 351 g/eq.

### Aldimine A3: N,N′-bis(2,2-dimethyl-3-(N-morpholino)propylidene)-3-aminomethyl-3,5,5-trimethylcyclohexylamine

170.3 g (1 mol) 3-aminomethyl-3,5,5-trimethylcyclohexylamine (Vestamin® IPD, from Evonik) were placed in a round bottom flask under nitrogen atmosphere. Then 359.5 g (2.1 mol) 2,2-dimethyl-3-(N-morpholino)propanal were added under good stirring, followed by removing the volatile contents at 80° C. and 10 mbar vacuum. The yield was 493.2 g of a nearly colourless liquid with an amine content of 8.25 mmol N/g, corresponding to a calculated aldimine equivalent weight of approx. 247 g/eq.

### Manufacture of Aldimine Preparations:

The viscosity was measured with a thermostated cone-plate-viscometer Rheotec RC30 (cone diameter 50 mm, cone angle 1°, cone-plate-distance 0.05 mm, shear rate 50 s⁻¹).

The FT-IR spectroscopy is measured on a Bruker Alpha Eco-ATR as undiluted films.

### Aldimine Preparation-1:

91.75 g Aldimine A1 (250 mmol C═N) were placed in a round bottom flask under nitrogen atmosphere. Then 9.26 g isophorone diisocyanate (Vestanat® IPDI, from Evonik) (83.3 mmol NCO) were added under good stirring, followed by 1.50 g (83.3 mmol) water and 0.05 g salicylic acid. The reaction mixture was stirred at 80° C. and regularly checked by FT-IR spectroscopy until the signal of the isocyanate groups could not be detected anymore. Then, the reaction mixture was cooled to room temperature and stored in a sealed container.

The yield was 102.5 g of a clear yellowish liquid with a viscosity at 20° C. of 76 Pa·s and a calculated aldimine equivalent weight of 615.2 g/eq.

### Aldimine Preparation-2:

117.4 g diisononyl 1,2-cyclohexanedicarboxylate (Hexamoll® DINCH, from BASF) were placed in a round bottom flask under nitrogen atmosphere. Then 49.53 g Aldimine A1 (135 mmol C═N) and 5.0 isophorone diisocyanate (Vestanat® IPDI, from Evonik) g (45 mmol NCO) were added under good stirring, followed by 0.81 g (45 mmol) water and 0.2 g salicylic acid. The reaction mixture was stirred at 80° C. and regularly checked by FT-IR spectroscopy until the signal of the isocyanate groups could not be detected anymore. Then, the reaction mixture was cooled to room temperature and stored in a sealed container.

The yield was 172.5 g of a clear yellowish liquid with a viscosity at 20° C. of 0.12 Pa·s and a calculated aldimine equivalent weight of 1928.5 g/eq.

### Aldimine Preparation-3:

117.4 g diisononyl 1,2-cyclohexanedicarboxylate (Hexamoll® DINCH, from BASF) were placed in a round bottom flask under nitrogen atmosphere. Then 47.37 g Aldimine A2 (135 mmol C═N) and 5.0 g isophorone diisocyanate (Vestanat® IPDI, from Evonik) (45 mmol NCO) were added under good stirring, followed by 0.81 g (45 mmol) water and 0.2 g salicylic acid. The reaction mixture was stirred at 80° C. and regularly checked by FT-IR spectroscopy until the signal of the isocyanate groups could not be detected anymore. Then, the reaction mixture was cooled to room temperature and stored in a sealed container.

The yield was 170.5 g of a slightly turbid white liquid with a calculated aldimine equivalent weight of 1898 g/eq.

### Aldimine Preparation-4:

129.92 g diisononyl 1,2-cyclohexanedicarboxylate (Hexamoll® DINCH, from BASF) were placed in a round bottom flask under nitrogen atmosphere. Then, 0.65 g 1,4-butanediol (14.4 mmol OH) were added, followed by 6.41 g isophorone diisocyanate (Vestanat® IPDI, from Evonik) (57.6 mmol NCO). The mixture was heated to 60° C. under stirring and regularly checked by FT-IR spectroscopy until the integral of the signal of the isocyanate groups remained constant. Then 47.6 g Aldimine A1 (129.8 mmol C═N) were added, followed by 0.78 g (43.3 mmol) water and 0.05 g salicylic acid. The reaction mixture was stirred at 80° C. until the signal of the isocyanate groups in the FT-IR spectrum could not be detected anymore. Then, the reaction mixture was cooled to room temperature and stored in a sealed container.

The yield was 184.3 g of a slightly turbid liquid with a viscosity at 20° C. of 0.12 Pa·s and a calculated aldimine equivalent weight of 2145.3 g/eq.

### Aldimine Preparation-5:

117.4 g diisononyl 1,2-cyclohexanedicarboxylate (Hexamoll® DINCH, from BASF) were placed in a round bottom flask under nitrogen atmosphere. Then 49.9 g Aldimine A1 (117 mmol C═N) and 5.0 g isophorone diisocyanate (Vestanat® IPDI, from Evonik) (45 mmol NCO) were added under good stirring, followed by 0.81 g (45 mmol) water and 0.2 g salicylic acid. The reaction mixture was stirred at 80° C. and regularly checked by FT-IR spectroscopy until the signal of the isocyanate groups could not be detected anymore. Then, the reaction mixture was cooled to room temperature and stored in a sealed container.

The yield was 166 g of a clear yellowish liquid with a calculated aldimine equivalent weight of 2312.4 g/eq.

### Aldimine Preparation-6:

117.4 g diisononyl 1,2-cyclohexanedicarboxylate (Hexamoll® DINCH, from BASF) were placed in a round bottom flask under nitrogen atmosphere. Then 36.3 g Aldimine A1 (99 mmol C═N) and 5.0 g isophorone diisocyanate (Vestanat® IPDI, from Evonik) (45 mmol NCO) were added under good stirring, followed by 0.81 g (45 mmol) water and 0.2 g salicylic acid. The reaction mixture was stirred at 80° C. and regularly checked by FT-IR spectroscopy until the signal of the isocyanate groups could not be detected anymore. Then, the reaction mixture was cooled to room temperature and stored in a sealed container.

The yield was 159 g of a slightly turbid white liquid with a calculated aldimine equivalent weight of 2960.4 g/eq.

### Aldimine Preparation-7:

61.75 g Aldimine A3 (250 mmol C═N) were placed in a round bottom flask under nitrogen atmosphere. Then 5.56 g isophorone diisocyanate (Vestanat® IPDI, from Evonik) (50 mmol NCO) were added under good stirring, followed by 0.90 g (50 mmol) water and 0.05 g salicylic acid. The reaction mixture was stirred at 80° C. and regularly checked by FT-IR spectroscopy until the signal of the isocyanate groups could not be detected anymore. Then, the reaction mixture was cooled to room temperature and stored in a sealed container.

The yield was 68 g of a clear yellowish liquid with a viscosity at 20° C. of 476 Pa·s and a calculated aldimine equivalent weight of 341.3 g/eq.

### Aldimine Preparation-8:

61.75 g Aldimine A3 (250 mmol C═N) were placed in a round bottom flask under nitrogen atmosphere. Then 6.56 g 4,4′-diisocyanatodicyclohexylmethane (Desmodur® W/1, from Covestro) (50 mmol NCO) were added under good stirring, followed by 0.90 g (50 mmol) water and 0.05 g salicylic acid. The reaction mixture was stirred at 80° C. and regularly checked by FT-IR spectroscopy until the signal of the isocyanate groups could not be detected anymore. Then, the reaction mixture was cooled to room temperature and stored in a sealed container.

The yield was 69 g of a clear, yellowish liquid with a viscosity at 40° C. of 426 Pa·s and a calculated aldimine equivalent weight of 346.3 g/eq.

### Aldimine Preparation-9:

49.8 g 1-methoxy-2-propylacetate (MPA) were placed in a round bottom flask under nitrogen atmosphere. Then 42.7 g Aldimine A3 (173 mmol C═N) and 6.4 g (57.6 mmol NCO) isophorone diisocyanate (Vestanat® IPDI, from Evonik) were added under good stirring, followed by 1.04 g (57.6 mmol) water and 0.05 g salicylic acid. The reaction mixture was stirred at 80° C. and regularly checked by FT-IR spectroscopy until the signal of the isocyanate groups could not be detected anymore. Then, the reaction mixture was cooled to room temperature and stored in a sealed container.

The yield was 98 g of a clear yellowish liquid with a viscosity at 20° C. of 31 mPa·s and a calculated aldimine equivalent weight of 868 g/eq.

### Aldimine Preparation-10:

49.8 g 1-methoxy-2-propylacetate (MPA) were placed in a round bottom flask under nitrogen atmosphere. Then 0.97 g 1,4-butanediol (21.6 mmol OH) were added, followed by 9.61 g isophorone diisocyanate (Vestanat® IPDI, from Evonik) (86.4 mmol NCO). The mixture was heated to 60° C. under stirring and regularly checked by FT-IR spectroscopy until the integral of the signal of the isocyanate groups remained constant. Then 42.7 g Aldimine A3 (173 mmol C═N) were added, followed by 1.17 g (65 mmol) water and 0.05 g salicylic acid. The reaction mixture was stirred at 80° C. until the signal of the isocyanate groups in the FT-IR spectrum could not be detected anymore. Then, the reaction mixture was cooled to room temperature and stored in a sealed container.

The yield was 102 g of a slightly turbid yellowish liquid with a viscosity at 20° C. of 0.13 Pa·s and a calculated aldimine equivalent weight of 966 g/eq.

### Aldimine Preparation-11:

49.8 g 1-methoxy-2-propylacetate (MPA) were placed in a round bottom flask under nitrogen atmosphere. Then 2.59 g 1,4-butanediol (57.6 mmol OH) were added, followed by 12.81 g isophorone diisocyanate (Vestanat® IPDI, from Evonik) (115.2 mmol NCO). The mixture was heated to 60° C. under stirring and regularly checked by FT-IR spectroscopy until the integral of the signal of the isocyanate groups remained constant. Then 42.7 g Aldimine A3 (173 mmol C═N) were added, followed by 1.04 g (57.6 mmol) water and 0.05 g salicylic acid. The reaction mixture was stirred at 80° C. until the signal of the isocyanate groups in the FT-IR spectrum could not be detected anymore. Then, the reaction mixture was cooled to room temperature and stored in a sealed container.

The yield was 108 g of a slightly turbid yellowish liquid with a viscosity at 20° C. of 0.37 Pa·s and a calculated aldimine equivalent weight of 936 g/eq.

### Aldimine Preparation-12 (Non-Inventive):

250.0 g of an isocyanat-functional polymer with an NCO-content of 1.8 weight-% (107 mmol NCO), which was prepared as described below, was placed in a round bottom flask under nitrogen atmosphere. Then 78.7 g Aldimine A1 (214 mmol C═N) were added under good stirring, followed by 1.93 g water (107 mmol) and 0.05 g salicylic acid. The reaction mixture was stirred at 80° C. and regularly checked by FT-IR spectroscopy until the signal of the isocyanate groups could not be detected anymore. Then, the reaction mixture was cooled to room temperature and stored in a sealed container. The obtained aldimine preparation gelled within one day and could not be liquified when heated to 60° C. It was therefore not usable.

The isocyanat-functional polymer was prepared by reacting 400 g polyoxypropylene diol (Acclaim® 4200, OH-number 28.5 mg KOH/g, from Covestro) and 52 g 4,4′-methylenediphenyl diisocyanate (MDI, Desmodur® 44 MC L, from Covestro) at 80° C. to an NCO-content of 1,5 weight-%, as described in US 2013/130039 for polyurethanepolymer P1 which was used for Emulsion E1.

TABLE 1
Calculated composition and properties of the prepared Aldimine Preparations.

| | Aldimine Preparation | | | | | |
|---|---|---|---|---|---|---|
| | −1 | −2 | −3 | −4 | −5 | −6 |
| used educts: | A1 | A1 | A2 | A1 | A1 | A1 |
| aldimine (I) | (250 mmol C = N | (135 mmol C = N) | (135 mmol C = N) | (129.8 mmol C = N) | (117 mmol C = N) | (99 mmol C = N) |
| isocyanate (II) | IPDI | IPDI | IPDI | IPDI | IPDI | IPDI |
| | (83.3 mmol NCO) | (45 mmol NCO) | (45 mmol NCO) | (57.6 mmol NCO) | (45 mmol NCO) | (45 mmol NCO) |
| 1,4-butanediol | — | — | — | (14.4 mmol OH) | — | — |
| water | (83.3 mmol) | (45 mmol) | (45 mmol) | (43.3 mmol) | (45 mmol) | (45 mmol) |
| ratios: | 3/1 | 3/1 | 3/1 | 3/1 | 2.6/1 | 2.2/1 |
| C = N/[NCO − OH] | | | | | | |
| OH/NCO | — | — | — | 0.25/1 | — | — |
| H₂O/[NCO − OH] | 1/1 | 1/1 | 1/1 | 1/1 | 1/1 | 1/1 |
| composition: | — | DINCH | DINCH | DINCH | DINCH | DINCH |
| aprotic organic liquid | | 68.0 wt-% | 68.7 wt-% | 70.1 wt-% | 70.6 wt-% | 73.5 wt-% |
| aldehyde | 23.1 wt-%¹ | 7.4 wt-%¹ | 7.5 wt-%¹ | 6.6 wt-%¹ | 7.7 wt-%¹ | 8.0 wt-%¹ |
| oligomers of the | 76.9 wt-% | 24.6 wt-% | 23.8 wt-% | 23.3 wt-% | 21.7 wt-% | 18.5 wt-% |
| formula (VI) | (m = 0) | (m = 0) | (m = 0) | (m > 0) | (m = 0) | (m = 0) |
| properties: | 76 (20° C.) | 0.12 (20° C.) | n.d. | 0.12 (20° C.) | n.d. | n.d. |
| viscosity [Pa · s] | | | | | | |
| aldimine eq. wt [g/eq] | 615.2 | 1928.5 | 1898 | 2145.3 | 2312.4 | 2960.4 |

| | Aldimine Preparation | | | | | |
|---|---|---|---|---|---|---|
| | | | | | | −12 |
| | −7 | −8 | −9 | −10 | −11 | (non-inventive) |
| used educts: | A3 | A3 | A3 | A3 | A3 | A1 |
| aldimine (I) | (250 mmol | (250 mmol | (173 mmol | (173 mmol | (173 mmol | (214 mmol |
| | C = N) | C = N) | C = N) | C = N) | C = N) | C = N) |
| isocyanate (II) | IPDI | H12MDI | IPDI | IPDI | IPDI | isocyanate-functional |
| | (50 mmol NCO) | (50 mmol NCO) | (57.6 mmol NCO) | (86.4 mmol NCO) | (115.2 mmol NCO) | polymer |
| | | | | | | (107 mmol NCO) |
| 1,4-butanediol | — | — | | (21.6 mmol OH) | (57.6 mmol OH) | — |
| water | (50 mmol) | (50 mmol) | (57.6 mmol) | (65 mmol) | (57.6 mmol) | (107 mmol) |
| ratios: | 5/1 | 5/1 | 3/1 | 2.7/1 | 3/1 | 2/1 |
| C = N/[NCO − OH] | | | | | | |
| OH/NCO | — | — | — | 0.25/1 | 0.5/1 | — |
| H₂O/[NCO − OH] | 1/1 | 1/1 | 1/1 | 1/1 | 1/1 | 1/1 |
| composition: | — | — | MPA | MPA | MPA | — |
| aprotic organic | | | 50.0 wt-% | 47.7 wt-% | 45.7 wt-% | |
| liquid | | | | | | |
| aldehyde | 12.54 wt-%² | 12.36 wt-%² | 9.9 wt-%² | 12.3 wt-%² | 15.1 wt-%² | 9.2 wt-%¹ |
| oligomers of the | 87.46 wt-% | 87.64 wt-% | 40.1 wt-% | 40.0 wt-% | 39.2 wt-% | non inventive |
| formula (VI) | (m = 0) | (m = 0) | (m = 0) | (m > 0) | (m > 0) | |
| properties: | 476 (20° C.) | 426 (40° C.) | 0.03 (20° C.) | 0.13 (20° C.) | 0.37 (20° C.) | gelled |
| viscosity [Pa · s] | | | | | | |
| aldimine eq. wt [g/eq] | 341.3 | 346.3 | 868 | 966 | 936 | 3088 |

¹2,2-dimethyl-3-lauroyloxypropanal
²2,2-dimethyl-3-(N-morpholino)propanal
“n.d.” means “not determined”

### Preparation of Isocyanate-Functional Polyurethane Polymers:

The viscosity was measured with a thermostated cone-plate-viscometer Rheotec RC30 (cone diameter 25 mm, cone angle 1°, cone-plate-distance 0.05 mm, shear rate 10 s⁻¹).

The content of monomeric diisocyanates was determined by HPLC (detection by photodiode array, 0.04 M sodium acetate/acetonitrile mobile phase) after derivatization with N-propyl-4-nitrobenzylamine.

### Polymer P1:

780 g ethyleneoxide-capped polyoxypropylene triol (Desmophen® 5031 BT, OH-number 28.0 mg KOH/g, from Covestro) and 220 g isophorone diisocyanate (Vestanat® IPDI, from Evonik) were reacted at 80° C. according to known procedures to form a mixture with an NCO-content of 6.4 weight-% and a content of monomeric isophorone diisocyanate of approximately 12 weight-%. The volatile contents, particularly most of the monomeric isophorone diisocyanate, were then removed from the mixture in a short path evaporator by distillation (jacket temperature 160° C., 0.1 to 0.005 mbar). The polymer obtained had an NCO-content of 1.9 weight-%, a viscosity of 8.2 Pa·s at 20° C. and a content of monomeric isophorone diisocyanate of 0.02 weight-%.

### Polymer P2:

600 g polyoxypropylene diol (Voranol® 1010 L, OH-number 112 mg KOH/g, from Dow) and 400 g isophorone diisocyanate (Vestanat® IPDI, from Evonik) were reacted at 80° C. according to known procedures to form a mixture with an NCO-content of 10 weight-% and a content of monomeric isophorone diisocyanate of approximately 13 weight-%. The volatile contents, particularly most of the monomeric isophorone diisocyanate, were then removed from the mixture in a short path evaporator by distillation (jacket temperature 160° C., 0.1 to 0.005 mbar). The polymer obtained had an NCO-content of 5.5 weight-%, a viscosity of 21.8 Pa·s at 20° C. and a content of monomeric isophorone diisocyanate of 0.03 weight-%.

### Polymer P3:

818 g polyoxypropylene diol (Acclaim© 4200, OH-number 28.5 mg KOH/g, from Covestro) and 182 g isophorone diisocyanate (Vestanat® IPDI, from Evonik) were reacted at 80° C. according to known procedures to form a mixture with an NCO-content of 5.1 weight-% and a content of monomeric isophorone diisocyanate of approximately 9 weight-%. The volatile contents, particularly most of the monomeric isophorone diisocyanate, were then removed from the mixture in a short path evaporator by distillation (jacket temperature 160° C., 0.1 to 0.005 mbar). The polymer obtained had an NCO-content of 1.9 weight-%, a viscosity of 6.5 Pa·s at 20° C. and a content of monomeric isophorone diisocyanate of 0.03 weight-%.

### Moisture-Curing Polyurethane Compositions:

Compositions C₁ to C₂₀:

For each composition, the ingredients given in the Tables 2 to 6 were mixed under exclusion of moisture in a sealed polypropylene beaker by means of a centrifugal mixer (SpeedMixer™ DAC 150, FlackTek Inc.) until a homogeneous mixture was obtained, which was then filled and stored in a moisture-tight container.

The compositions were tested as follows:

The viscosity was measured with a thermostated cone-plate-viscometer Rheotec RC30 (cone diameter 25 mm, cone angle 1°, cone-plate-distance 0.05 mm, shear rate 10 s⁻¹) at 20° C. after 1 day storage in normal climate (“1d NC”) and again after 7 days storage in an oven at 60° C. (“7d 60° C.”). A small increase in viscosity indicates a particularly good storage stability.

The skinning time (skin formation time) was determined in normal climate, by applying a few grams of the composition in a layer thickness of approx. 2 mm on cardboard and gently touching its surface with an LDPE pipette from time to time, until the touching did not leave any residues on the pipette.

The surface tack was judged by touching with the finger after 12 hours or after 24 hours and after 2 days curing in normal climate on the samples which were used for the determination of the Shore A hardness. The scale is: tacky>medium>slight>dry.

To determine the mechanical properties, the composition was poured onto a PTFE coated plate in a layer thickness of approx. 2 mm and stored in normal climate for 7 days, followed by punching dumbbell shaped samples out of the cured film with a length of 75 mm at a bridge length of 30 mm and a bridge width of 4 mm. With the so-prepared samples, the tensile strength, the elongation (at break), the e-modulus 5% (from 0.5 to 5% elongation) and the e-modulus 50% (from 0.5 to 50% elongation) were determined according to DIN EN 53504 at a crosshead speed of 200 mm/min.

The Shore A hardness was determined according to DIN 53505 with cylindrical samples of 20 mm diameter and a thickness of 5 mm after 7 days storage in normal climate for the compositions C₁ to C₁₂, or after 6 days storage in normal climate followed of 1 day in an oven at 60° C. for the compositions C₁₃ to C₂₀.

The cured films of all the compositions were homogeneous and bubble-free.

The test results are given in the Tables 2 to 6.

Reference examples are marked with “(Ref.)”.

The compositions C₁ to C₁₂ are particularly suitable as adhesive and/or sealant. The compositions C₁₃ to C₂₀ are particularly suitable as coating for the waterproofing of low slope roofs.

TABLE 2
Composition (in weight parts) and test results of the Compositions C1 to C6.

| Composition | | C1 | C2 (Ref.) | C3 | C4 (Ref.) | C5 | C6 (Ref.) |
|---|---|---|---|---|---|---|---|
| Polymer P1 | | 80.00 | 80.00 | 80.00 | 80.00 | 80.00 | 80.00 |
| Aldimine Preparation-1 | | 14.77 | — | | | | |
| Aldimine Preparation-2 | | — | — | 46.30 | — | — | — |
| Aldimine Preparation-3 | | — | — | — | — | 52.69 | — |
| Aldimine A1 | | — | 8.81 | — | 8.81 | — | — |
| Aldimine A2 | | — | — | — | — | — | 9.73 |
| DINCH¹ | | — | — | — | 31.33 | — | 31.33 |
| salicylic acid solution² | | 1.50 | 1.50 | 1.50 | 1.50 | 1.50 | 1.50 |
| DBTDL solution³ | | 0.50 | 0.50 | 0.50 | 0.50 | 0.50 | 0.50 |
| viscosity [Pa · s] | 1 d NC | 12.9 | 12.4 | 4.2 | 3.0 | 2.9 | 3.2 |
| | 7 d 60° C. | 17.7 | 16.2 | n.d. | n.d. | n.d. | n.d. |
| skinning time | | 115′ | 80′ | 180′ | 260′ | 110′ | 90′ |
| surface tack | 24 h | slight | medium | n.d. | n.d. | n.d. | n.d. |
| | 2 d | dry | medium | n.d. | n.d. | n.d. | n.d. |

| | | | | | | |
|---|---|---|---|---|---|---|
| tensile strength [MPa] | 2.07 | 1.88 | 2.21 | 1.32 | 1.13 | 0.43 |
| elongation [%] | 300 | 350 | 457 | 426 | 435 | 202 |
| e-modulus 5% [MPa] | 1.71 | 1.09 | 0.66 | 0.34 | 0.24 | 0.22 |
| e-modulus 50% [MPa] | 1.07 | 0.70 | 0.46 | 0.28 | 0.20 | 0.20 |
| Shore A | 42 | 34 | 23 | 15 | 18 | 13 |

“n.d.” means “not determined”
¹diisononyl 1,2-cyclohexanedicarboxylate (Hexamoll ® DINCH, from BASF)
²5 weight-% salicylic acid in dioctyl phthalate
³5 weight-% dibutyltindilaurate in diisodecylphthalate

TABLE 3
Composition (in weight parts) and test
results of the Compositions C7 to C9.

| Composition | | C7 | C8 | C9 (Ref.) |
|---|---|---|---|---|
| Polymer P1 | | 80.00 | 80.00 | 80.00 |
| Aldimine Preparation-2 | | 46.30 | — | — |
| Aldimine Preparation-4 | | — | 57.07 | — |
| Aldimine A1 | | — | — | 8.81 |
| Aldimine A2 | | — | — | — |
| DINCH¹ | | 8.55 | — | 39.95 |
| salicylic acid solution² | | 1.50 | 1.50 | 1.50 |
| DBTDL solution³ | | 0.50 | 0.50 | 0.50 |
| viscosity | 1 d NC | 3.0 | 3.7 | 2.5 |
| [Pa · s] | 7 d 60° C. | 3.8 | 4.9 | 3.0 |
| skinning time | | 180′ | 110′ | 260′ |
| surface tack | 24 h | medium | slight | tacky |
| | 2 d | slight | slight | medium |

| | | | |
|---|---|---|---|
| tensile strength [MPa] | 2.19 | 2.01 | 1.31 |
| elongation [%] | 480 | 450 | 445 |
| e-modulus 5% [MPa] | 0.70 | 0.79 | 0.35 |
| e-modulus 50% [MPa] | 0.48 | 0.51 | 0.31 |
| Shore A | 23 | 24 | 17 |

¹diisononyl 1,2-cyclohexanedicarboxylate (Hexamoll ® DINCH, from BASF)
²5 weight-% salicylic acid in dioctyl phthalate
³5 weight-% dibutyltindilaurate in diisodecylphthalate

TABLE 4
Composition (in weight parts) and test
results of the Compositions C10 to C12.

| Composition | | C10 | C11 | C12 |
|---|---|---|---|---|
| Polymer P1 | | 48.00 | 48.00 | 48.00 |
| Aldimine Preparation-2 | | 19.84 | — | — |
| Aldimine Preparation-5 | | — | 23.79 | — |
| Aldimine Preparation-6 | | — | — | 30.46 |
| DINCH¹ | | 9.60 | 6.0 | — |
| salicylic acid solution² | | 0.90 | 0.90 | 0.90 |
| DBTDL solution³ | | 0.30 | 0.30 | 0.30 |
| viscosity | 1 d NC | 3.7 | 4.4 | 4.8 |
| [Pa · s] | 7 d 60° C. | 4.8 | 5.7 | 7.3 |

| | | | |
|---|---|---|---|
| skinning time | 240′ | 290′ | 330′ |
| tensile strength [MPa] | 1.22 | 1.37 | 1.95 |
| elongation [%] | 397 | 418 | 540 |
| e-modulus 5% [MPa] | 0.36 | 0.33 | 0.35 |
| e-modulus 50% [MPa] | 0.27 | 0.26 | 0.27 |
| Shore A | 16 | 15 | 13 |

¹diisononyl 1,2-cyclohexanedicarboxylate (Hexamoll ® DINCH, from BASF)
²5 weight-% salicylic acid in dioctyl phthalate
³5 weight-% dibutyltindilaurate in diisodecylphthalate

TABLE 5
Composition (in weight parts) and test
results of the Compositions C13 to C15.

| | | | |
|---|---|---|---|
| Composition | C13 | C14 | C15 (Ref.) |

| Polymer P2 | | 11.00 | 11.00 | 11.00 |
|---|---|---|---|---|
| Polymer P3 | | 22.00 | 22.00 | 22.00 |
| IPDI-Isocyanurate solution¹ | | 3.57 | 3.57 | 3.57 |
| Aldimine Preparation-7 | | 9.38 | — | — |
| Aldimine Preparation-8 | | — | 9.52 | — |
| Aldimine A3 | | — | — | 6.79 |
| 1-methoxy-2-propyl acetate | | 15.00 | 15.00 | 15.00 |
| ATH² | | 25.00 | 25.00 | 25.00 |
| titanium dioxide | | 5.00 | 5.00 | 5.00 |
| fumed silica | | 2.00 | 2.00 | 2.00 |
| salicylic acid solution³ | | 1.00 | 1.00 | 1.00 |
| viscosity | 1 d NC | 2.1 | 2.1 | 1.8 |
| [Pa · s] | 7 d 60° C. | 3.2 | 2.9 | 2.3 |
| skinning time | | 65′ | 55′ | 75′ |
| surface tack | 12 h | dry | dry | dry |

| | | | |
|---|---|---|---|
| tensile strength [MPa] | 8.1 | 6.5 | 6.7 |
| elongation [%] | 545 | 460 | 570 |
| e-modulus 5% [MPa] | 38.5 | 32.6 | 22.1 |
| e-modulus 50% [MPa] | 6.6 | 6.2 | 5.5 |
| Shore A | 78 | 79 | 66 |

¹Desmodur ® Z 4470SN (70 weight-% in solventnaphtha 100, NCO-content 12.0 weight-%, from Covestro)
²aluminium trihydroxide powder
³10 weight-% in 1-methoxy-2-propyl acetate

TABLE 6
Composition (in weight parts) and test
results of the Compositions C16 to C20.

| Composition | | C16 | C17 | C18 | C19 | C20 (Ref.) |
|---|---|---|---|---|---|---|
| Polymer P2 | | 11.00 | 11.00 | 11.00 | 11.00 | 11.00 |
| Polymer P3 | | 22.00 | 22.00 | 22.00 | 22.00 | 22.00 |
| IPDI-Isocyanurate | | 3.57 | 3.57 | 3.57 | 3.57 | 3.57 |
| solution¹ | | | | | | |
| Aldimine | | 7.46 | — | — | — | — |
| Preparation-9 | | | | | | |
| Aldimine | | — | 8.30 | — | — | — |
| Preparation-10 | | | | | | |
| Aldimine | | — | — | 16.07 | 8.04 | — |
| Preparation-11 | | | | | | |
| Aldimine A3 | | 2.12 | 2.12 | — | 2.12 | 4.24 |
| 1-methoxy-2-propyl | | 11.27 | 10.85 | 7.55 | 11.27 | 15.00 |
| acetate | | | | | | |
| ATH² | | 25.00 | 25.00 | 25.00 | 25.00 | 25.00 |
| titanium dioxide | | 5.00 | 5.00 | 5.00 | 5.00 | 5.00 |
| fumed silica | | 2.00 | 2.00 | 2.00 | 2.00 | 2.00 |
| salicylic acid | | 1.00 | 1.00 | 1.00 | 1.00 | 1.00 |
| solution³ | | | | | | |
| viscosity | 1 d NC | 2.7 | 2.9 | 4.1 | 3.0 | 2.2 |
| [Pa · s] | 7 d 60° C. | 4.6 | 5.9 | 9.0 | 5.4 | 3.1 |
| skinning time | | 110′ | 110′ | 110′ | 110′ | 120′ |
| surface | 24 h | medium | medium | medium | medium | medium |
| tack | 2 d | dry | slight | dry | slight | medium |

| | | | | | |
|---|---|---|---|---|---|
| tensile strength [MPa] | 3.5 | 4.4 | 2.9 | 3.0 | 2.6 |
| elongation [%] | 460 | 516 | 320 | 385 | 455 |
| e-modulus 5% [MPa] | 9.6 | 12.1 | 11.4 | 9.1 | 6.5 |
| e-modulus | 3.4 | 4.0 | 3.5 | 3.4 | 2.4 |
| 50% [MPa] | | | | | |
| Shore A | 62 | 64 | 59 | 60 | 56 |

¹Desmodur ® Z 4470SN (70 weight-% in solventnaphtha 100, NCO-content 12.0 weight-%, from Covestro)
²aluminium trihydroxide powder
³10 weight-% in 1-methoxy-2-propyl acetate

1. Process of manufacturing an aldimine preparation, wherein
at least one aldimine of the formula (I),
at least one isocyanate of the formula (II),
optionally at least one alcohol of the formula (III), 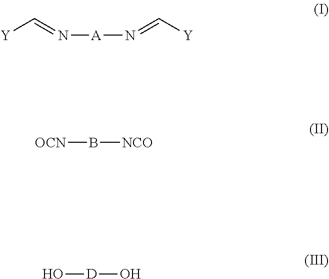
wherein
Y is a monovalent C₁ to C₂₀ hydrocarbon group or a monovalent C₄ to C₂₀ hydrocarbon group containing ester or ether oxygen and/or tertiary amine nitrogen,
A is a divalent C₂ to C₂₀ hydrocarbon group,
B is a divalent C₄ to C₁₅ hydrocarbon group, and
D is a C₂ to C₆ alkylene group,
and water
are reacted until at least 95% of all the initially present isocyanate groups are converted, whereby the initial molar ratio of aldimine groups to [isocyanate groups minus hydroxyl groups of the alcohol of formula (III)] in the reaction mixture is in the range of 2/1 to 10/1.

2. Process according to claim 1, wherein the initial molar ratio of water to [isocyanate groups minus hydroxyl groups of the alcohol of formula (III)] is in the range of 1/1 to 1.2/1.

3. Process according to claim 1, wherein the initial molar ratio of aldimine groups to [isocyanate groups minus hydroxyl groups of the alcohol of formula (III)] is in the range of 2.1/1 to 7/1.

4. Process according to claim 1, wherein A is the divalent radical after removing the amine groups of a diamine selected from the group consisting of 1,6-hexanediamine, isophorone diamine, 4(2)-methyl-1,3-cyclohexanediamine, 4,4′-methylene-bis(cyclohexylamine) and 1,3-bis(aminomethyl)cyclohexane.

5. Process according to claim 1, wherein Y is a group of the formula (IV), 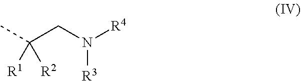
wherein
R¹ and R² are the same or different C₁ to C₄ alkyls, or are joined together to form a C₄ to C₆ alkylene, and
R³ and R⁴ are the same or different C₁ to C₈ alkyls or C₃ to C₈ alkyls containing ether oxygen,
or R³ and R⁴ are joined together to form a C₄ to C₆ alkylene or a C₄ to C₆ alkylene containing ether oxygen.

6. Process according to claim 1, wherein Y is a group of the formula (V), 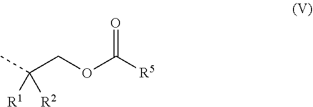
wherein
R¹ and R² are the same or different C₁ to C₄ alkyls, or are joined together to form a C₄ to C₆ alkylene, and
R⁵ is hydrogen or a monovalent C₁ to C₁₇ hydrocarbon optionally containing ether groups.

7. Process according to claim 1, wherein the isocyanate of the formula (II) is selected from the group consisting of 1,6-hexane diisocyanate, isophorone diisocyanate, 4,4′-diisocyanatodicyclohexylmethane, diphenylmethane diisocyanate and toluene diisocyanate.

8. Process according to claim 1, wherein A and B are the same divalent radicals.

9. Process according to claim 1, wherein at least one aprotic organic liquid is present, which has no Zerevitinov-active hydrogen atoms, is liquid at room temperature and miscible with the aldimine preparation.

10. Aldimine preparation obtained from the process according to claim 1 comprising aldimine group containing oligomers and at least one aldehyde of the formula 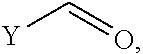
wherein the aldimine preparation contains less than 0.5 weight-% water and less than 0.05 weight-% isocyanate groups based on the total aldimine preparation.

11. Aldimine preparation according to claim 10, wherein the aldimine group containing oligomers are oligomers of the formula (VI), 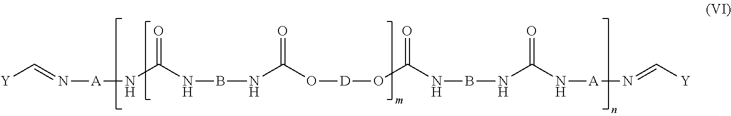
in which
n is a natural number in the range of 0 to 5,
m is a natural number in the range of 0 to 3,
and on average in the aldimine preparation, n is in the range of 0.25 to 2.5 and m is in the range of 0 to 2.

12. A latent hardener for moisture-curing polyurethane compositions comprising the aldimine preparation according to claim 10.

13. Moisture-curing polyurethane composition comprising
at least one isocyanate-functional polymer with an NCO-content in the range of 0.5 to 8 weight-% based on the total polymer, and
the aldimine preparation according to claim 10.

14. Moisture-curing polyurethane composition according to claim 13, wherein the isocyanate functional polymer has a content of diisocyanate monomers below 0.5 weight-%, based on the total polymer, and is obtained from the reaction of at least one diisocyanate monomer and at least one polyol at a molar NCO/OH-ratio of at least 3/1, followed by removing diisocyanate monomers by a distillation process.

15. Elastic adhesive, elastic sealant, elastic coating, primer, paint or varnish obtained from the moisture-curing polyurethane composition according to claim 13 after its contact with moisture.
